(19) United States
(12) Patent Application Publication
(10) Pub. No.: US 2015/0286648 A1
(43) Pub. Date: Oct. 8, 2015

(54) USER TERMINAL FOR SEARCHING MULTI DATA AND SEARCHING METHOD THEREOF

(71) Applicant: Konan Technology Inc., Seoul (KR)

(72) Inventors: Deok Ho YOON, Yongin-si (KR); Jeong Sun PARK, Yongin-si (KR)

(73) Assignee: Konan Technology Inc., Seoul (KR)

(21) Appl. No.: 14/679,584

(22) Filed: Apr. 6, 2015

(30) Foreign Application Priority Data
Apr. 7, 2014 (KR) 10-2014-0041459

(51) Int. Cl. G06F 17/30; H04L 12/58

(52) U.S. Cl. CPC G06F 17/3087; H04L 51/22

(57) ABSTRACT

A user terminal for searching multiple data and a searching method thereof. According to an exemplary embodiment of the present disclosure, the user terminal includes: a search engine configured to index data acquired from a plurality of user terminals of a user and data associated with a web-based service, search for an index of data requested by the user, and to provide a search result; an interface configured to receive an instruction from the user and output a result of processing the instruction; and a search engine agent configured to relay connection between an interface of each of the plurality of user terminals and the search engine so as to transmit the search result obtained by the search engine to an interface of a search request terminal.

### CROSS-REFERENCE TO RELATED APPLICATION(S)

This application claims priority from Korean Patent Application No. 10-2014-0041459, filed on Apr. 7, 2014, in the Korean Intellectual Property Office, the entire disclosure of which is incorporated herein by reference for all purposes.

### BACKGROUND

1. Field

The following description relates to a technology of searching for data and providing found data.

2. Description of the Related Art

Generally, localized search methods are used to search for data in a user terminal. That is, in response to a query input by a user, the user terminal searches for data requested by the query and provides a search result to the user. For example, to search for an audio file stored in a smart phone, a user inputs a search query to an interface of the smart phone. The query may include keywords associated with an audio clip, an album title, or an artist's name. Then, the smart phone searches for the requested audio file and provides the user with the audio file as a search result.

However, if the requested audio file is stored in a different terminal belonging to the user, such as a laptop, the audio file cannot be found by searching only the smart phone. Hence, it is required to provide a technology that helps a user to search for desired data, no matter where the data is stored.

### SUMMARY

The following description relates to a user terminal for searching multi data and a searching method thereof, wherein the user terminal is capable of easily and quickly, at anytime, searching for data stored in a plurality of user terminals and data associated with a web-based service.

In one general aspect, there is provided a user terminal including: a search engine configured to index data acquired from a plurality of user terminals of a user and data associated with a web-based service, search for an index of data requested by the user, and provide a search result; an interface configured to receive an instruction from the user and output a result of processing the instruction; and a search engine agent configured to relay connection between an interface of each of the plurality of user terminals and the search engine so as to transmit the search result obtained by the search engine to an interface of a search request terminal of the plurality of user terminals.

The data acquired from the plurality of user terminals may include file data of the user terminal, mail data of the user terminal, and file attribute information acquired by a different user terminal through the search engine agent. The data associated with the web-based service may include data acquired through at least one of a cloud storage service, a note application, and a web mail service.

The search engine may be further configured to monitor whether a file-related event occurs in the user terminal, and, in response to occurrence of the file-related event, index file attribute information and context of a file to which the file-related event has occurred. The search engine may be further configured to index a file at predetermined time intervals by inspecting whether there is a file whose status has been changed since the last inspection and by indexing file attribute information and context of the file whose status has been changed.

The search engine may be further configured to index data of a mail service provided through the user terminal, by indexing content and an attachment of an e-mail using a Message Application Programming Interface (MAPI) library or an Internet Message Access Protocol (IMAP), wherein, in the case of using the IMAP, the search engine receives, from the interface of the search request terminal, an IMAP address, a port, user identification (ID), a password, and whether to use Secure Socket Layer (SSL).

The search engine may be further configured to index cloud data stored in a cloud storage by performing the following operations: receiving a file list from a cloud storage; inspecting the file list to see whether there is a file whose status has been changed since the last file indexing; if it turns out that there is a file whose status has been changed, requesting and receiving the file from the cloud storage; and indexing the file The search engine may be further configured to index the cloud data only in response to receipt from the interface of an indexing request and an authentication key for user authentication, which is acquired for settings of the interface.

The search engine may be further configured to index data of a note application provided to the user terminal, by searching a note application server for a list of messages which have occurred since the last indexing, receiving a message to be indexed, and indexing the received message. The search engine may be further configured to index the data of the note application only in response to receipt from the interface of an indexing request and an authentication key for user authentication, which is acquired when setting the interface.

The search engine may be further configured to receive file attribute information from a mobile terminal through the search engine agent and periodically index the file attribute information, in a case where the mobile terminal is a different user terminal in which indexing is performed.

The search engine agent may be further configured to, in response to receipt of a search request from the of the search request terminal, transmit the search request to the search engine, receive a search result from the search engine, and transmit the search result the interface of the search request terminal.

The search engine agent may be further configured to connect directly to the interface of the search request terminal using a local IP address of NAT IP address thereof, or connect to the interface of the search request terminal via a relay server. The local IP address or NAT IP address may be collected by the search engine agent when connecting to the relay server, and transmitted from the search engine to the interface of the search request terminal in response to a search request from the interface of the search request terminal.

The search engine agent may be further configured to, in response to receipt of a file download request from an interface of a specific terminal that has received a search result, transmit a file requested for download to the interface of the specific user terminal. The interface of the specific user terminal may activate the search engine agent only in response to receipt of a download preparation request through a push server from the interface of the search request terminal, and the activated search engine may transmit the file requested for download to the interface of the search request terminal.

In another general aspect, there is provided a data searching method of a user terminal, including: indexing data acquired from a plurality of user terminals of a user and data associated with a web-based service; receiving a data search request from a different user terminal of the user; and searching for an index of data requested by the received data search request and providing a search result to the different user terminal.

In yet another general aspect, there is provided a data searching method of a user terminal, including: receiving a data search request from a user and transmitting the data search request to a search terminal of the user so as to request a search of data; and receiving a search result from the search terminal in a case where a user terminal receives the data search request and searches for requested data in indexes of data acquired from a plurality of user terminals of the user and data associated with a web-based service.

Other features and aspects may be apparent from the following detailed description, the drawings, and the claims.

### BRIEF DESCRIPTION OF THE DRAWINGS

FIG. 1 is a diagram illustrating a configuration of a searching system according to an exemplary embodiment of the present disclosure.

FIG. 2 is a diagram illustrating a detained configuration of a searching system according to an exemplary embodiment of the present disclosure.

FIG. 3 is a flowchart illustrating a method for indexing a file according to an exemplary embodiment of the present disclosure.

FIG. 4 is a flowchart illustrating a method for indexing an e-mail according to an exemplary embodiment of the present disclosure.

FIG. 5 is a flowchart illustrating a method for indexing an e-mail according to another exemplary embodiment of the present disclosure.

FIG. 6 is a flowchart illustrating a method for indexing cloud data according to an exemplary embodiment of the present disclosure.

FIG. 7 is a flowchart illustrating a method for indexing data of a note application according to an exemplary embodiment of the present disclosure.

FIG. 8 is a flowchart illustrating a method for indexing data of a mobile terminal according an exemplary embodiment of the present disclosure.

FIG. 9 is a flowchart illustrating a method for searching data according to an exemplary embodiment of the present disclosure.

FIG. 10 is a flowchart illustrating a method for downloading a search result according to an exemplary embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

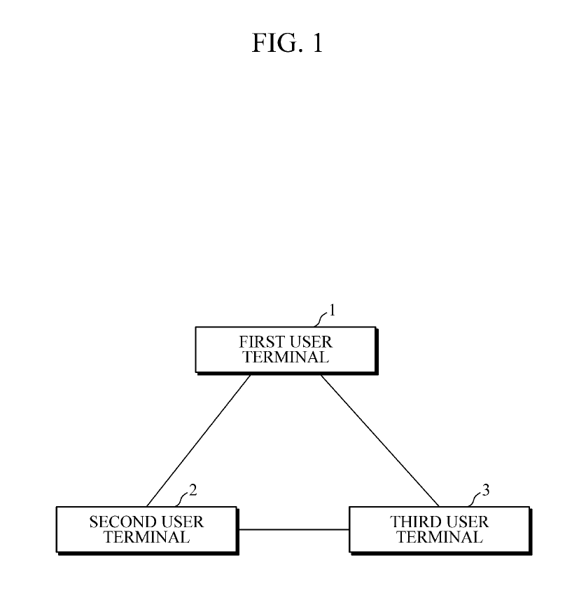

FIG. 1 is a diagram illustrating a configuration of a searching system according to an exemplary embodiment of the present disclosure.

Referring to FIG. 1, a searching system according to an exemplary embodiment provides a service that enables a user to easily and quickly search for data stored in various user terminals possessed by the user. A user terminal may be a personal computer (PC), such as a laptop, a desktop, and a tablet PC, or a mobile terminal such as a smart phone. For convenience of explanation, FIG. 1 shows three user terminals, e.g., the first user terminal 1, the second user terminal 2, and the third user terminal 3. In FIG. 1, it is assumed that the first user terminal 1 is a PC installed at home, that the second user terminal 2 is a PC used at work, and that the third user terminal 3 is a portable smart phone.

The searching system supports a user to search for data stored in a user terminal using another user terminal. For example, on a business trip, a user is able to search for data stored in the home PC 1 or the office PC 2 with the smart phone 3. In another example, when coming back home after work, the user is able to search for data stored in the office PC 2 or the smart phone 3 with the home PC 1. Although the three user terminals 1, 2, and 3 are taken as examples, the number and types of user terminals are not limited thereto. Once a user joins a search service, the searching system registers user terminals designated by the user and provides a search service to the registered user terminals.

The searching system supports searching and downloading of attribute information and context of any file generated in any user terminal of a user. In addition, the searching system provides a mail search service which enables searching a title, context, and an attachment of an e-mail. Further, using the searching system, it is possible to search for and share even data that are generated through a web-based service. The web-based service, which indicates a web-based service provided on the web, includes a cloud service and a note application service. The cloud service is a service for storing data in a cloud storage, such as Google Drive and Dropbox, and the note application service includes Evernote.

The searching system stores search indexes in a user terminal, not in an additional server, thereby preventing privacy infringe or security problem that may occur when the search indexes is stored in the additional server.

The searching system displays a search result on a screen through an interface. A list of search result data may be displayed on a search target unit basis. For example, in a case where a user designates two PCs, two smart phones, Google Drive, Dropbox, and Evernote as search targets, if the user inputs a search keyword, a list of search result data obtained from each search target is displayed.

The searching system provides a list of search result files so that a user is able to download a specific file from among the search result files. Further, the user may share the downloaded file with others. There are various file sharing methods, for example, uploading the file to the cloud environment or SNS or transmitting the file to an e-mail address.

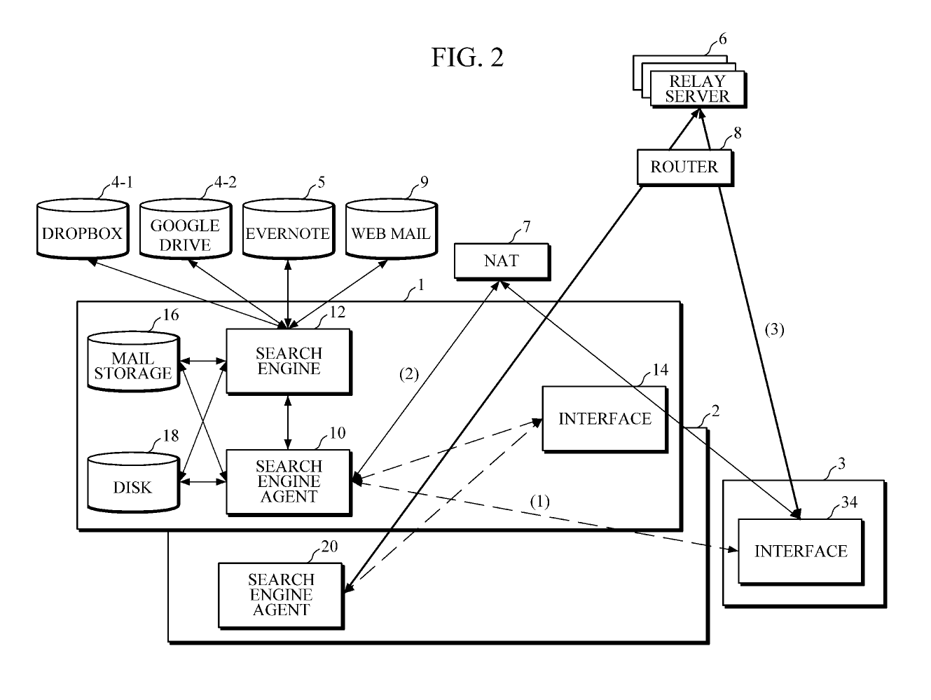

FIG. 2 is a diagram illustrating a searching system according to an exemplary embodiment of the present disclosure.

Referring to FIG. 2, there are three user terminals 1, 2, and 3, and each of the user terminals 1, 2, and 3 includes a search engine, a search engine agent, and an interface. Each of the elements may be a hardware device or a combination of software modules. The hardware device may be, for example, an integrated circuit including at least one processor, or a memory whose integrated circuit has a computer program code.

The interface receives an instruction from a user and outputs a result of processing the instruction. The interface may be an application that can be installed or downloaded in a user terminal. If the application is executed by a user, a data searching or downloading instruction may be received from the user through the application and a search result obtained by the search engine may be output through the application. The application has a browsing function and may be installed in a format suitable for an operating system of the user terminal. For example, if the application is to be installed in a PC, a windows- or MAC-version application may be installed. Alternatively, if the application is to be installed on a smart phone, an Android-version or iOS-version application may be installed.

The interface communicates with the search engine agent in order to request search and download of a file. For optimization of the communication, the interface makes the first attempt to connect to a search engine agent using a local IP address thereof in process 1. If the first attempt fails, the interface makes the second attempt to connect to a search engine agent using a NAT IP address thereof in process 2. If the second attempt fails, the interface makes the final attempt to connect to a search engine agent via a relay server 6 in process 3.

The search engine indexes data stored in user terminals and data related to a web-based service. In addition, in response to a data search request from a user, the search engine searches for an index of data requested by the request and provides a search result. Indexing indicates storing data-related information in a list or index. According to the present disclosure, it is possible to index not only attribute information of data, but also context thereof. For example, in a case where requested data is a file, the search engine may index attribute information and context of the file. In another example, in a case where requested is an e-mail, the search engine may index a title, context, and an attachment of the e-mail.

According to an exemplary embodiment, if a user designates a frequently-used terminal as a main terminal among various user terminals through an interface, a search engine of the main terminal indexes data stored in all user terminals possessed by the user. For example, in a case where the first user terminal 1, which is a user's home PC, is designated as the main terminal, a search engine 12 of the first user terminal 1 indexes data generated in the first user terminal 1, data acquired from the third user terminal, and data acquired through a service provided to the first user terminal 1 on the web.

The data generated in the first user terminal 1 may be a document file generated through a disk 18 and mail data stored in a mail storage 16. The mail data may include a title, context, and an attachment of an e-mail. The data acquired from the third user terminal 3 may be attribute information of a file generated in the third user terminal 3. The data acquired through a service provided to the first user terminal 1 on the web may be data acquired from a cloud storage, such as Dropbox 4-1 and Google Drive 4-2, data acquired from a note application, such as Evernote 5, data acquired from a web mail 9, and the like.

In the aforementioned indexing method that is based on a main terminal, the main terminal, that is, the first user terminal 1, indexes the above-mentioned data while each of the other user terminals 2 and 3 indexes only data generated therein. However, the above example is merely exemplary, and even the other user terminals 2 and 3 may perform the same function as that of the main terminal.

A search engine agent of each user terminal relays communication between a search engine and an interface. To this end, the search engine agent communicates with the interface, and the interface may be included in the same user terminal or a different user terminal. For example, as illustrated in FIG. 1, a search engine agent 10 of the first user terminal 1 may communicate with an interface 14 of the first user terminal 1 and an interface 34 of the third user terminal 3.

According to an exemplary embodiment, a search engine agent is configured to receive a search request from an interface and transmit the search request to a search engine, and to receive a file download request from the interface and transmit a file stored in a disk to the interface. The search engine agent may act not only as a server, but also as a client.

For example, the search engine agent communicates directly with the interface so as to receive a user's instruction from the interface and transmit a result of processing the instruction to the interface. The fact that the search engine agent communicates directly with the interface means that the interface is capable of connecting to the search engine agent using a local IP address or a NAT IP address of the search engine agent. If the search engine agent is not capable of communicating directly with the interface, that is, if it is hard for the interface to connect to the search engine agent using a local IP address or a NAT IP address thereof, the search engine agent acts as a client that receives and processes an instruction, received from the interface, through a relay server 6 to which the interface is able to connect all the time.

For the communication between the search engine agent and the interface, a local IP address and a NAT IP address of the search engine agent may be used. The local IP address and NAT IP address of the search engine agent may be collected by the relay server 6. For example, while a search engine agent 20 connects to the relay server 6, the relay server 6 collects a local IP address and a NAT IP address of the search engine agent 20. In addition, in response to a request from an interface 34, the search engine agent 20 transmits the local IP address and NAT IP address of the search engine agent 20 to the interface 34. In order to communicate with the search engine agent 20 using the NAT IP address thereof, a network address translation (NAT) 7 needs to implement port forwarding beforehand. Port forwarding indicates bypassing a message from a specific port of a NAT IP address to a specific port of a predetermined local IP address.

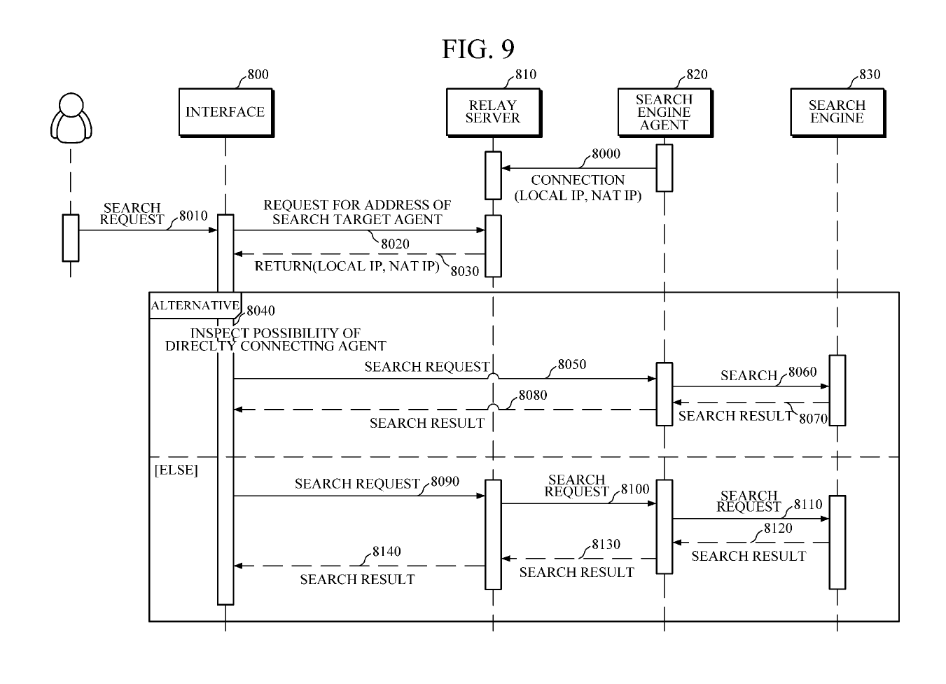

A search engine agent inside each of the first and second terminals 1 and 2, both of which are PCs, may be executed as a background process all the time. However, for the third user terminal 3 which is a mobile terminal, such as a smart phone, it is hard to execute the search engine agent as a background process. It is because a mobile terminal may run out of battery at some point and a local IP address may keep changing due to mobility of a mobile terminal. For these reasons, a search engine agent of a mobile terminal is executed only in response to receipt of a user's request, not all the time. Detailed descriptions thereof are provided with reference to FIG. 9.

The relay server 6 relays communication between an interface and a search engine agent when the interface is unable to communicate directly with the search engine agent due to a firewall. For example, in a 3G, LTE, or any other network, the relay server 6 transmits an instruction, which is input through the interface, to the search engine agent on behalf of the interface for a purpose of smooth communication between the interface and the search engine agent.

A router 8 is a server using which the same user is able to connect to the relay server 6. That is, the router 8 allocates the same relay server 6 to the same user so as to enable a search engine agent and an interface to connect to the same relay server. By doing so, it is possible to prevent unnecessary communication with the relay server, which may occur when user terminals of the same user are distributed to different relay servers.

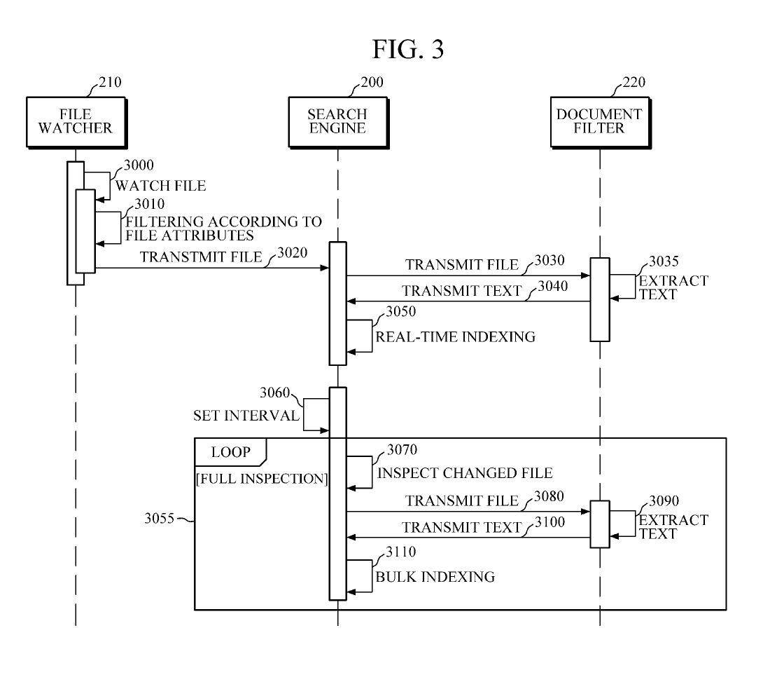

FIG. 3 is a flowchart illustrating a method for indexing a file according to an exemplary embodiment of the present disclosure.

Referring to FIG. 3, the method for indexing a file includes real-time indexing and bulk indexing. Real-time indexing indicates a process of receiving an event, such as creating, modifying, and deleting of a file in an operating system (OS), and then indexing the file in real time. Bulk indexing indicates a process of indexing an omitted file through a full inspection that is performed at a preset time. A user may set an arbitrary time to perform a full inspection. For example, the time may be set to be a time when the user does not use a corresponding terminal, e.g., 2:00 am.

According to an exemplary embodiment, a real-time indexing process is performed as follows. In 3000, a file watcher 210 monitors whether a file-related event, such as generating, modifying, or deleting of a file, occurs. If any file-related event occurs, the file watcher 210 transmits a requested file to a search engine 200 in 3200. Before transmitting the requested file to the search engine 200, the file watcher 212 may filter the file according to attributes thereof in 3010 in order to enhance efficiency of the indexing process. For example, through the filtering operation, a file belonging to an unnecessary system folder or a subordinate folder thereof, or a hidden file may be excluded from the indexing process. Then, the search engine 200 transmits the received file to the document filter 220 in 3030. After the document filter 220 extracts text from the file in 3035 and transmits the extracted text to the search engine 200 in 3040, the search engine 200 indexes attribute information and context of the file in 3050.

According to an exemplary embodiment, a bulk indexing process 3055 is performed as follows. The search engine 200 sets time intervals in 3060, and inspects in 3070 whether there is a file whose status has been changed, for example, if any file has been created or deleted. Then, the search engine 200 transmits to the document filter 220 a file whose status has been changed since the last inspection in 3080. After the document filter 220 extracts text from the file in 3090 and transmits the extracted text to the search engine 200 in 3100, the search engine 200 indexes file attribute information and context of the file in 3110.

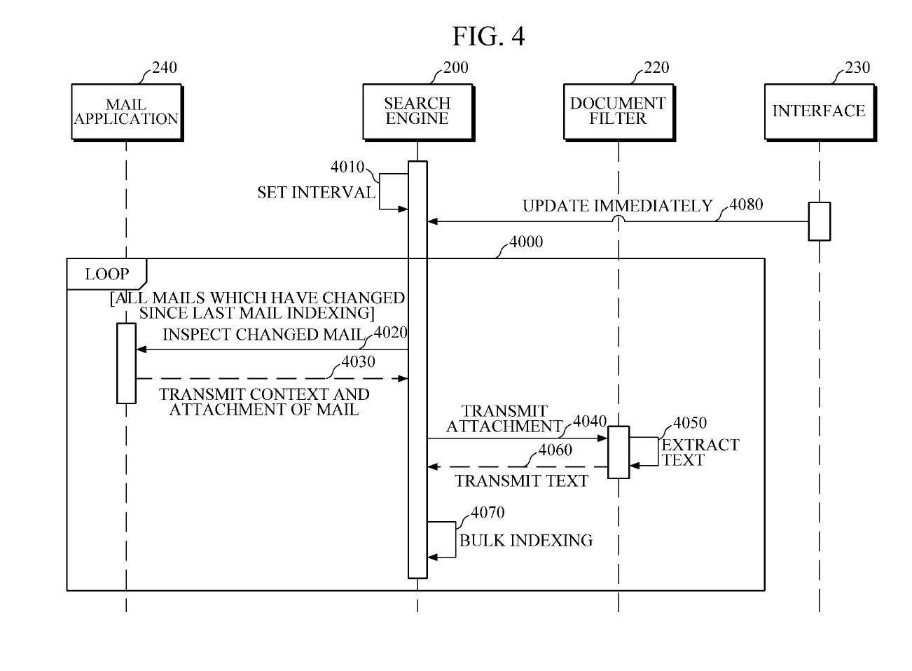

FIG. 4 is a flowchart illustrating a method for indexing an e-mail according to an exemplary embodiment of the present disclosure. Specifically, FIG. 4 is a flowchart illustrating a method for indexing an Outlook mail.

Referring to FIG. 4, the method for indexing an e-mail implements bulk indexing. The mail indexing enables indexing context and an attachment of an e-mail using Messaging Application Program Interface (MAPI) library provided by Microsoft. For mail indexing, a bulk indexing process 4000 may be performed at a preset time, for example, once a day at 3:00 am. Additionally, even in a case where an interface 230 requests the search engine 200 to update immediately in 4080, the bulk indexing process 4000 may be performed.

According to an exemplary embodiment, the bulk indexing process 4000 is performed as follows. The search engine 200 sets time interval in 4010, and inspects in 4020 whether there is an e-mail whose status has been changed, for example, whether any email has been created or deleted, a mail application program, such as Outlook, since the last mail indexing. If there is an e-mail whose status has been changed, the search engine 200 receives context and an attachment from a mail application program 240 in 4030. Then, the search engine 200 transmits to the document filter 220 the attachment of the e-mail whose status has been changed in 4040. After the document filter 220 extracts text from the attachment in 4050 and transmits the extracted text to the search engine 200 in 4060, the search engine 200 indexes context and the attachment of the e-mail in 4070.

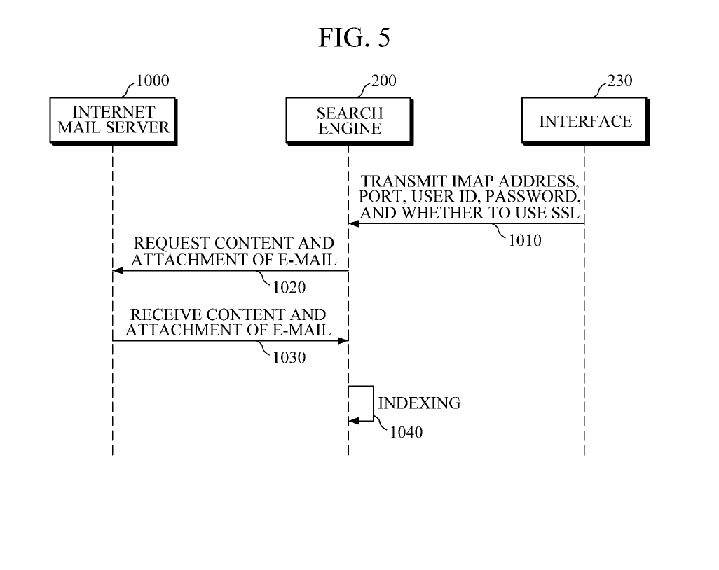

FIG. 5 is a flowchart illustrating a method for indexing an e-mail according to another exemplary embodiment. Specifically, FIG. 5 is a flowchart illustrating a method for indexing a webmail.

Referring to FIG. 5, an Internet Messaging Access Protocol (IMAP), rather than a MAPI library, is used to download content and an attachment of an e-mail and index the same. The IMAP is one of the Internet standard protocols for retrieving e-mails from an Internet mail server 1000.

In the case of indexing web mails, an Open Authentication (OAuth) key is not used. Instead, the interface 230 acquires an IMAP address, a port, user identification (ID), a password, and whether to use Secure Socket Layer (SSL), and transmits the acquired information to the search engine 200 to request an indexing operation in 1010. Then, the search engine 200 requests content and an attachment of an e-mail from the Internet mail server 100 in 1020, receives the requested content and attachment in 1030, and indexes the received content and attachment in 1040.

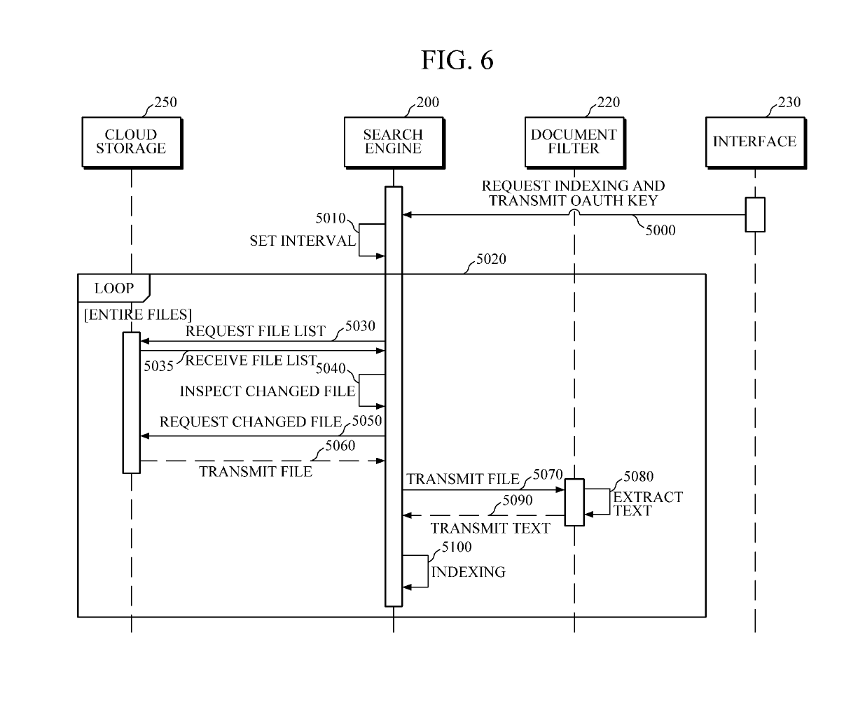

FIG. 6 is a flowchart illustrating a method for indexing cloud data according to an exemplary embodiment of the present disclosure.

Referring to FIG. 6, an Open Authentication (OAuth) key is necessary to authenticate a user in order to index data in a cloud storage such as Google Drive or Dropbox. The OAuth key is an open standard for authorization, which has been developed as open Application Programming Interface (API), and may be used to authenticate a user in various applications. When setting the interface, the OAuth key may be acquired by a user. First, the interface 230 transmits the acquired OAuth key to the search engine 200 to request an indexing process in 5000.

The method for indexing cloud data can be implemented only using a bulk indexing process 5020, and the bulk indexing process 5020 may be performed at predetermined time intervals, i.e., every ten minutes. In the bulk indexing process 5020, the search engine 200 receives the OAuth key from the interface 230 in 5000. Then, the search engine 200 sets time intervals in 5010; requests a list of files stored in a cloud storage 250 at predetermined time intervals in 5030; and receives the list of files from the cloud storage 250 in 5035. The search engine 200 checks in 5040 whether there is a file whose status has been changed, for example, if any file has been created or deleted, from among the received list of flies since the last indexing process. If it is found there is a file whose status has been changed, the search engine 200 requests the changed file from the cloud storage 250 in 5050 and receives the changed file from the cloud storage 250 in 5060.

Then, the search engine 200 transmits the changed file to the document filter 220 in 5070. After the document filter 220 extracts text from the changed file in 5080 and transmits the extracted text to the search engine 200 in 5090, the search engine 200 indexes the file in 5100. The aforementioned method is to select a file to be indexed, receive only the selected file from the cloud storage 250, and index the selected file. For the method for indexing cloud data, the search engine 200 receives a file from the cloud storage 250 in 5060 and indexes the received file in 5100, and, after the indexing process is complete, the search engine 200 may delete the file.

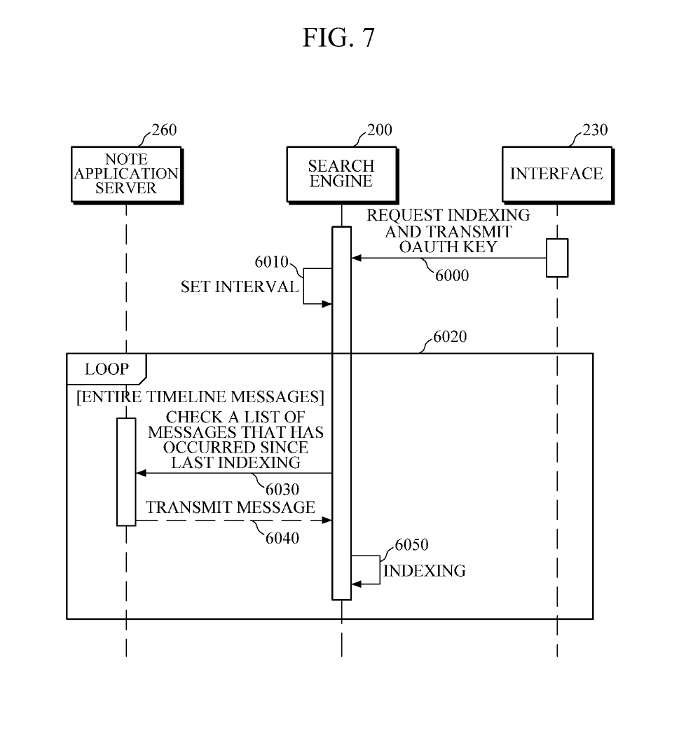

FIG. 7 is a flowchart illustrating a method for indexing data of a note application according to an exemplary embodiment of the present disclosure.

Referring to FIG. 7, an OAuth key is necessary to index data of a note application such as Ever note. When setting environments of the interface 230, an OAuth key may be acquired by a user. First, the interface 230 transmits the acquired OAuth key to the search engine and requests an indexing process in 6000. Then, the search engine 200 performs bulk indexing at predetermined time intervals, i.e., every ten minutes, on a note application's data stored in a note application server 260 in 6020. In the SNS data bulk indexing process 6020, the search engine 200 searches the note application server 260 for a list of messages that has occurred since the last indexing in 6030, receives from the SNS server 260 a message to be indexed in 6040, and indexes the received message in 6050.

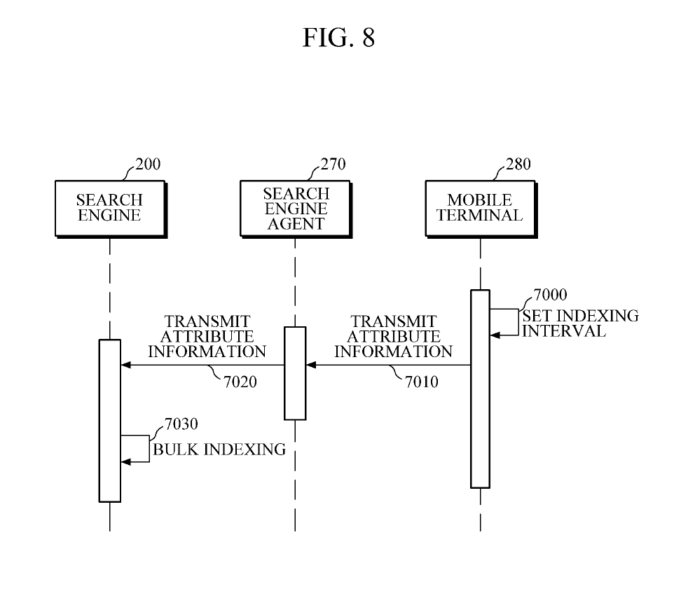

FIG. 8 is a flowchart illustrating a method for indexing mobile terminal data according to an exemplary embodiment of the present disclosure.

Referring to FIG. 8, a search engine 200 is not able to connect directly to a mobile terminal 280. Thus, the mobile terminal 280 collects attribute information of a file and transmits the collected attribute information of the file to a search engine agent 270 in 7010 at predetermined time intervals. In response, a search engine agent 270 transmits the collected attribute information of the file to the search engine 200 in 7020. Then, the search engine 200 indexes the collected attribute information of the file in 7030. At this point, context of the file is not indexed. The aforementioned indexing scheme is bulk indexing that is performed when the mobile terminal 280 transmits attribute information of a file at predetermined time intervals, and the transmission time intervals may be set by the mobile terminal 280 in 7000.

FIG. 9 is a flowchart illustrating a method for searching data according to an exemplary embodiment of the present disclosure.

Referring to FIG. 9, when a search engine agent 820 of a search terminal connects to a relay server 810 using a local IP address or NAT IP address of the search engine agent 820 in 8000, the relay server 810 collects the local IP address or NAT IP address of the search engine agent 820. If a user's request for searching data is received through an interface 800 of a search request terminal in 8010, the interface 800 requests the local IP address or NAT IP address of the search engine agent 820 from a relay server 810 in 8020, and receives the same in 8030.

In 8040, the interface 800 checks whether it is possible to connect directly to the search engine agent 820 using the received local IP address or NAT IP address thereof. If possible, the interface 800 connects to the search engine agent 820 using the received local IP address or NAT IP address, and requests the search engine agent 820 to search data in 8050. Then, the search engine agent 820 requests a search engine 830 to search data in 8060. As the search engine 830 performs a search in response to the request, the search engine agent 820 receives a search result from the search engine 830 in 8070, and transmits the search result to the interface 800 in 8080. The search result may provide information on whether the requested data exists in the search terminal; if so, a list of found data may be provided.

If it is not possible to connect to the search engine agent 820 using the received local IP address or NAT IP address thereof, the interface 800 requests the search engine agent 820 via the relay server 810 to search data in 8090 and 8100. Then, the search engine agent 820 requests the search engine 830 to search data in 8110, receives a search result from the search engine 830 in 8120, and transmits the search result to the interface 800 via the relay server 810 in 8130 and 8140.

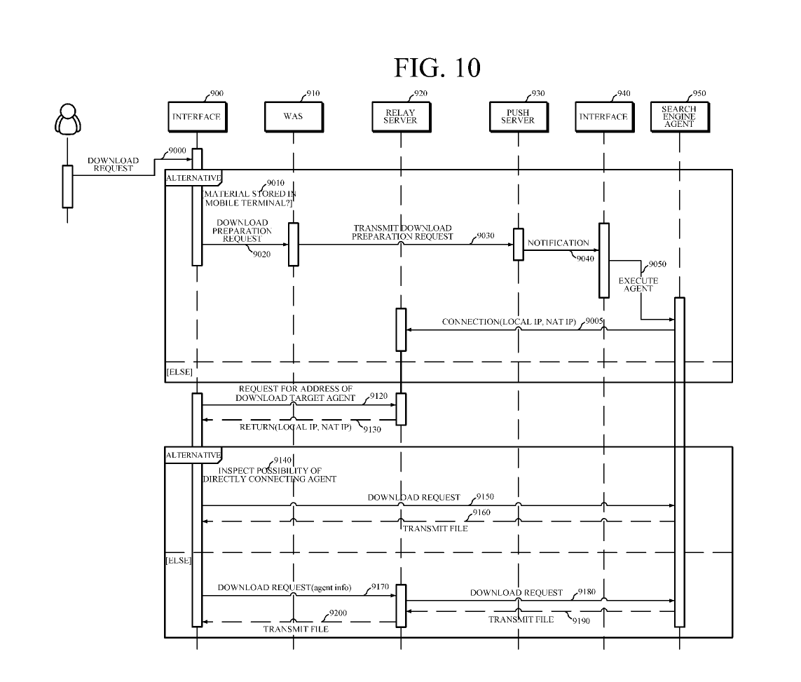

FIG. 10 is flowchart illustrating a search result data downloading method according to an exemplary embodiment of the present disclosure.

Referring to FIG. 10, a search request terminal is able to download a file found by a search terminal and share the downloaded file. The search request terminal and the search terminal may be a PC or a mobile terminal.

The search request terminal may download a file in various ways according to a location where the file is stored. For example, if an original file is stored in a PC, the search request terminal connects to a search engine agent of a search terminal through an interface of the search request terminal to download the file. If the interface of the search request terminal is not able to connect directly to the search engine agent of the search terminal, the search request terminal may download the file from the search engine agent of the search terminal via a relay server. At this point, the file may be a file stored in a disk of the search terminal or may be an attachment to an e-mail stored in the search terminal.

Specifically, referring to FIG. 9, in a case where user wants to download data, found by a search terminal, through an interface 900 of a search request terminal in 9000, a search engine agent 950 of the search terminal connects to a relay server 920 using a local IP address or NAT IP address of the search engine agent 950 in 9005. If the search engine agent 950 of the search terminal connects to a relay server 920 using the local IP address or NAT IP address of the search engine agent 950 in 9005, the interface 900 of the search request terminal requests the relay server 920 to transmit the local IP address or NAT IP address collected by the relay server 920 in 9120, and then received the local IP address or NAT IP address from the relay server 920 in 9130.

Then, in 9140, the interface 900 of the search request terminal inspects whether it is possible to connect directly to the search engine agent 950 of the search terminal using the received local IP address or NAT IP address. If it is possible, the interface 900 connects to the search engine agent 950 using the local IP address or NAT IP address in order to request download of a file in 9150, and downloads the file from the search engine agent 950 in 9160. Alternatively, if it is not possible, the interface 900 requests download of a file from the search engine agent 950 via the relay server 920 in 9170 and 9180, and downloads the file from the search engine agent 950 via the relay server 920 in 9190 and 9200.

If a file to be downloaded is stored in a mobile terminal, not in a PC, the process is more complicated. A search engine agent of a mobile terminal cannot be executed as a background process, because a mobile terminal may run out of battery at some point and a local IP address may keep changing due to mobility of a mobile terminal. For this reason, in order to download a file, a search request terminal according to an exemplary embodiment executes a search engine agent of a mobile terminal, which is a search terminal. At this point, in response to receipt of a download preparation request, an interface of the mobile terminal executes the search engine agent 950 to enable the search request terminal to download the file. Similarly, in a case where it is not impossible to connect directly to the search engine agent, the interface of the mobile terminal receives the file from the search engine agent via a relay server.

Specifically, referring to FIG. 9, in a case where a user wants to download a file via the interface 900 of the search request terminal in 9000, if the search terminal is a mobile terminal, the interface requests a Web Application Server (WAS) 910 to prepare a downloading operation in 9020. The WAS 910 is a server that is in charge of managing members, downloading and introducing applications, and providing help information and notifications. The WAS 910 transmits a download preparation request to a push server 930 in 9030. Then, in 9040, using push services, the push server 930 notifies an interface 940 of the mobile terminal that the download preparation request has been received. In response to the notification, the interface 940 of the mobile terminal executes the search engine agent 950 in 9050. Then, the search engine agent 950 connects to the interface 900 of the search request terminal to transmit a file, and the interface 900 of the search request terminal downloads the file in 9150 and 9160. In another example, the interface 900 of the search request terminal may download the file from the search engine agent 950 via the relay server 920 in 9170, 9180, 9190, and 9200. Meanwhile, in the case of a cloud service or a note application, it is possible to download a file using an Application Programming Interface (API) provided by a vendor.

According to an exemplary embodiment, data stored in a plurality of user terminals and data associated with a web-based service may be searched conveniently and quickly anytime. In addition, search indexes are generated and stored in a user terminal, not in an additional server, thereby preventing privacy infringe or security problem that may occur when the search indexes are stored in the additional server. Further, a user is able to download a found file and share the downloaded file.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A user terminal comprising:
a search engine configured to index data acquired from a plurality of user terminals of a user and data associated with a web-based service, search for an index of data requested by the user, and provide a search result;
an interface configured to receive an instruction from the user and output a result of processing the instruction; and
a search engine agent configured to relay connection between an interface of each of the plurality of user terminals and the search engine so as to transmit the search result obtained by the search engine to an interface of a search request terminal of the plurality of user terminals.

2. The user terminal of claim 1, wherein the data acquired from the plurality of user terminals comprises file data of the user terminal, mail data of the user terminal, and file attribute information acquired by a different user terminal through the search engine agent.

3. The user terminal of claim 1, wherein the data associated with the web-based service comprises data acquired through at least one of a cloud storage service, a web application service, and a web mail service.

4. The user terminal of claim 1, wherein the search engine is further configured to monitor whether a file-related event occurs in the user terminal, and, in response to occurrence of the file-related event, index file attribute information and context of a file to which the file-related event has occurred.

5. The user terminal of claim 1, wherein the search engine is further configured to index a file at predetermined time intervals by inspecting whether there is a file whose status has been changed since the last inspection and by indexing file attribute information and context of the file whose status has been changed.

6. The user terminal of claim 1, wherein the search engine is further configured to index data of a mail service provided through the user terminal, by indexing content and an attachment of an e-mail using a Messaging Application Programming Interface (MAPI) library or an Internet Messaging Access Protocol (IMAP), wherein, in the case of using the IMAP, the search engine receives, from the interface, an IMAP address, a port, user identification ID, a password, and whether to use Secure Socket Layer (SSL).

7. The user terminal of claim 1, wherein the search engine is further configured to index cloud data stored in a cloud storage by performing the following operations: receiving a file list from a cloud storage; inspecting the file list to see whether there is a file whose status has been changed since the last file indexing; if it turns out that there is a file whose status has been changed, requesting and receiving the file from the cloud storage; and indexing the file.

8. The user terminal of claim 7, wherein the search engine is further configured to index the cloud data only in response to receipt from the interface of an indexing request and an authentication key for user authentication, which is acquired for settings of the interface.

9. The user terminal of claim 1, wherein the search engine is further configured to index data of a note application provided to the user terminal, by searching a note application server for a list of messages which have occurred since the last indexing, receiving a message to be indexed, and indexing the received message.

10. The user terminal of claim 9, wherein the search engine is further configured to index the note application data only in response to receipt from the interface of an indexing request and an authentication key for user authentication, which is acquired when setting the interface.

11. The user terminal of claim 1, wherein the search engine is further configured to receive file attribute information from a mobile terminal through the search engine agent and periodically index the file attribute information, in a case where the mobile terminal is a different user terminal in which indexing is performed.

12. The user terminal of claim 1, wherein the search engine agent is further configured to, in response to receipt of a search request from the of the search request terminal, transmit the search request to the search engine, receive a search result from the search engine, and transmit the search result the interface of the search request terminal.

13. The user terminal of claim 1, wherein the search engine agent is further configured to connect directly to the interface of the search request terminal using a local IP address of NAT IP address thereof, or connect to the interface of the search request terminal via a relay server.

14. The user terminal of claim 13, wherein the local IP address or NAT IP address is collected by the search engine agent when connecting to the relay server, and transmitted from the search engine to the interface of the search request terminal in response to a search request from the interface of the search request terminal.

15. The user terminal of claim 1, wherein the search engine agent is further configured to, in response to receipt of a file download request from an interface of a specific terminal that has received a search result, transmit a file requested for download to the interface of the specific user terminal.

16. The user terminal of claim 15, wherein the interface of the specific user terminal activates the search engine agent only in response to receipt of a download preparation request through a push server from the interface of the search request terminal, and the activated search engine transmits the file requested for download to the interface of the search request terminal.

17. A data searching method of a user terminal, comprising:
indexing data acquired from a plurality of user terminals of a user and data associated with a web-based service;
receiving a data search request from a different user terminal of the user; and
searching for an index of data requested by the received data search request and providing a search result to the different user terminal.

18. The data searching method of claim 17, wherein the providing of a search result comprises providing a search result of each user terminal for each service.

19. The data searching method of claim 17, further comprising:
based on the search result, providing a file requested by a user request.

20. A data searching method of a user terminal, comprising:
receiving a data search request from a user and transmitting the data search request to a search terminal of the user so as to request a search of data; and
receiving a search result from the search terminal in a case where a user terminal receives the data search request and searches for requested data in indexes of data acquired from a plurality of user terminals of the user and data associated with a web-based service.
